(19) United States
(12) Patent Application Publication
(10) Pub. No.: US 2011/0110608 A1
(43) Pub. Date: May 12, 2011

(54) Image transformation estimator of an imaging device

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo, JR., Bellevue, WA (US)

(73) Assignee: Searete LLC, a limited liability corporation of the State of Delaware

(21) Appl. No.: 12/799,372

(22) Filed: Apr. 23, 2010

Related U.S. Application Data
(63) Continuation of application No. 11/095,768, filed on Mar. 30, 2005, now abandoned.
Application No. 11/095,768 is a continuation-in-part of application No. 11/901,703, filed on Sep. 17, 2007, now abandoned.
Application No. 11/901,703 is a continuation-in-part of application No. 12/284,202, filed on Sep. 19, 2008, now abandoned.

(51) Int. Cl. G06K 9/32

(52) U.S. Cl. 382/299

(57) ABSTRACT

A technique includes obtaining an operational capacity of an imaging device. The technique can also include estimating one or more operational resources to perform an image transformation that estimates whether the imaging device has adequate operational capacity to transform one or more images.

The present application relates, in general, to operational capacities of imaging devices.

In one aspect, a method includes, but is not limited to, obtaining an imaging device energy value for the imaging device; and considering a resolution conversion energy level to indicate whether the imaging device has sufficient energy for converting one or more images from a first resolution to a second resolution based at least in part on the obtaining the imaging device energy value. In addition to the foregoing, other method aspects are described in the claims, drawings, and text forming a part of the present application.

In another aspect, an apparatus includes, but is not limited to, a device energy indicator operatively coupled to the imaging device, and configurable to indicate an energy value of the imaging device; and a resolution conversion energy indicator operatively coupled to the imaging device, and configurable to indicate whether the imaging device has the sufficient energy to convert a resolution of at least one image based at least in part on the energy value. In addition to the foregoing, other apparatus aspects are described in the claims, drawings, and text forming a part of the present application.

In another aspect, the imaging device includes, but is not limited to, an image capture portion configurable to capture at least a portion of at least one image; and a resolution conversion portion configurable to convert a resolution of the at least the portion of the at least one image. In addition to the foregoing, other apparatus aspects are described in the claims, drawings, and text forming a part of the present application.

In yet another aspect, the imaging device, comprising a resampling energy indicator configurable to indicate whether an at least a portion of an at least one image to be captured by the imaging device might be capable of being resampled based, at least in part, on at least an energy level of the imaging device. In addition to the foregoing, other apparatus aspects are described in the claims, drawings, and text forming a part of the present application.

In still another aspect, a method, comprising imaging an at least a portion of an at least one image with the imaging device; and resampling the at least the portion of the at least one image at the imaging device. In addition to the foregoing, other method aspects are described in the claims, drawings, and text forming a part of the present application.

In another aspect, a method, comprising obtaining an operational capacity of the imaging device; and estimating one or more operational resources to perform an image transformation that estimates whether the imaging device has adequate operational capacity to transform one or more images. In addition to the foregoing, other method aspects are described in the claims, drawings, and text forming a part of the present application.

In still another aspect, an apparatus, comprising a device operational capacity indicator operatively coupled to an imaging device, and configurable to estimate an operational capacity of the imaging device; and an image transformation estimator configurable to estimate whether the imaging device has adequate operational capacity to transform at least one image. In addition to the foregoing, other apparatus aspects are described in the claims, drawings, and text forming a part of the present application.

In one or more various aspects, related apparatus and systems include but are not limited to circuitry and/or programming for effecting the herein-referenced method aspects; the circuitry and/or programming can be virtually any combination of hardware, software, electro-mechanical systems, and/or firmware configured to effect the herein-referenced method aspects depending upon the choices of the system designer.

In addition to the foregoing, various other method and/or system aspects are set forth and described in the text (e.g., claims and/or detailed description) and/or drawings of the present application.

The foregoing thus contains, by necessity, simplifications, generalizations and omissions of detail; consequently, those skilled in the art will appreciate that this is illustrative only, and is not intended to be limiting. Other aspects, features, and advantages of the devices and/or processes and/or other subject matter described herein will become apparent in the text set forth herein.

### BRIEF DESCRIPTION OF THE FIGURES

FIG. 1 is a block diagram including one embodiment of an imaging device;

FIG. 2 is a schematic diagram including another embodiment of the imaging device;

FIG. 3 is a front view of one embodiment of an imaging system that includes one embodiment of an energy level indicator;

FIG. 4 is the front view of another embodiment of an imaging system that includes another embodiment of an energy level indicator;

FIG. 5 is a schematic diagram of one embodiment of a resolution conversion technique that increases resolution;

FIG. 6 is a schematic diagram of another embodiment of a resolution conversion technique that decreases resolution;

FIG. 7 is a schematic diagram of yet another embodiment of a resolution conversion technique that increases resolution.

FIG. 8 is a schematic diagram of yet another embodiment of the imaging device;

FIGS. 9a and 9b are flowcharts of one embodiment of a resolution conversion energy technique;

FIG. 10 is a schematic diagram of yet another embodiment of the imaging device;

FIG. 11 is a flowchart of one embodiment of a resampling technique;

FIG. 12 is a schematic diagram of yet another embodiment of the imaging device; and

FIGS. 13a, 13b, and 13c are flowcharts of an embodiment of an operational capacity technique.

The use of the same symbols in different drawings typically indicates similar or identical items.

### DETAILED DESCRIPTION

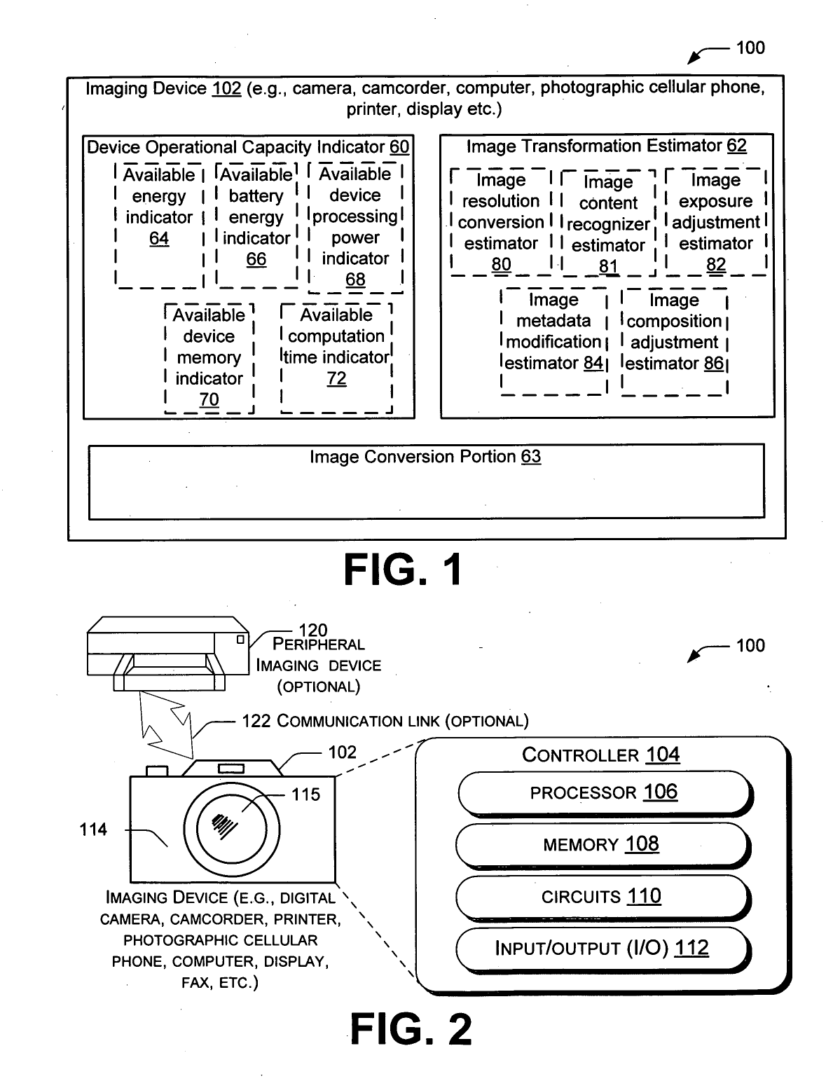

A variety of devices including, but not limited to, imaging devices 102 (one embodiment described with respect to FIG. 1), can be configured to perform a variety of functions. These functions include but are not limited to, imaging, capturing, obtaining, retaining, storing, storing and forwarding, and/or otherwise processing images. Certain embodiments of this disclosure provide a number of mechanisms to allow the imaging device to perform an image transformation of images associated with the imaging device. Illustrative examples of such image transformations include, but are not limited to, changing the resolution of one or more images, resampling one or more images, adjusting an exposure of one or more images, adjusting some image content recognition of the one or more images, adjusting image composition of one or more images, and/or modifying at least some metadata associated with the one more images.

Certain embodiments of image transformation can utilize certain embodiments of capacity within the imaging device. One embodiment of capacity includes device energy such as battery power. When the energy capacity for these imaging devices runs out, they are unable to operate as intended. For example, a camera having low battery power cannot, in many embodiments, properly image, capture, store, transfer, display, or perform some other desired operation for that device. By comparison, an image storage device having low memory storage capacity will only be able to store a certain number of images, or portions thereof. As soon as the image memory capacity becomes full, the image memory storage will not, in many embodiments, be capable of storing any more image information.

This disclosure provides a mechanism by which a number of device capacities to perform a prescribed image transforming operation can be estimated. As such, a user of the device will have some prior knowledge of whether an image transformation can be performed based on the device operational capacity. For example, a camera user can be prompted to show how many images can be transformed (e.g., the resolution changed, an image recognition query run on the images, etc) based on the current camera energy level.

This disclosure provides a number of embodiments of imaging devices that are configurable to perform a resolution conversion. With these imaging devices, a resolution conversion portion can be integrated within (or attached to) the imaging device, or alternatively can be located outside of the imaging device and operatively coupled thereto. Within this disclosure, the term “resolution” provides a measurement of image detail, and can be expressed using such units as pixels per inch, dots per inch, or samples per inch, etc. In certain embodiments, the file size of an image can be a function of its resolution; and with certain embodiments of relatively limited storage-capability cameras, relatively few high resolution images can be imaged or otherwise captured. Certain imaging devices may be configured to capture images and/or otherwise process images in prescribed resolutions that differ from other devices. One example of the image transformation includes converting the resolution of certain images depending upon their particular application and/or the configuration of the particular device. A number of imaging devices can therefore be configurable to perform one or more image transformations utilizing processing and/or other techniques.

Within the disclosure, the terms “images”, or “image information” can pertain to full images, portions of images, segments of full images, thumbnails of images, and/or information that describes particular images such as metadata (that can contain such information as the subject of the image, identifying who took the image, where the image was taken, the reference number of the image, etc.). Within this disclosure, metadata can be associated with a particular image or set of images. For example, a particular image may include metadata that describes such information as the subject of the image, the date and time of the image, location of the image, the owner of the imaging device, etc. It could be envisioned that the metadata that is associated with the particular image can be modified as, for example, the image itself being altered such as by changing the resolution. In certain embodiments, metadata can be used during processing of the image. For example, if it is desired to determine all images taken by a particular user or including a particular subject, the metadata can be queried to derive one or more images to satisfy that query. In this instance, the query represents one example of processing. The term “obtain” can apply to obtaining shared images either by capturing or by data transfer from another shared imaging device. The term “retain” can apply to storing shared images for some duration regardless how temporary or permanent the storage duration within a memory storage device. In many instances, a device obtaining an image also implies retaining the image.

Certain embodiments of still images can include photographs or digital images that can be captured by the imaging device such as, for example, a digital camera or photographic cell phone. Certain embodiments of motion images can include videos that may be captured by the imaging device such as, for example, a camcorder. A variety of embodiments of the sharing mechanism can therefore handle such exemplary shared images as digital still images or digital motion images that may be configured either alone or in combination with another media such as video, audio, music, etc.

The resolution conversion portion can in certain embodiments, but not others, act to alter the resolution of images that might have been captured or otherwise obtained. As described within this disclosure, certain embodiments of the resolution conversion portion may be configurable to increase or decrease the resolution of the image such as by utilizing pixel removal, pixel-interpolation, and/or combination of pixels from multiple image techniques. Different embodiments of the resolution conversion portion are described herein. Within this disclosure, the terms “resolution conversion” and “resampling” can in many instances, but not others, be considered similar since both can utilize processes that can include altering image intensity and/or color values of the image. Resampling can in certain embodiments, but not others, be equated to increasing or decreasing the resolution of at least a portion of an image. Resampling can, in certain embodiments but not others, be implemented by respectively adding or removing pixels from a given image as described in this disclosure.

Within this disclosure, the term “changing the resolution” of an image may pertain in certain embodiments, but not others, to altering the color values and/or the color intensities of a particular image. As such, increasing the resolution of an image can pertain to increasing the density of pixels, and can result from increasing variable color density values and/or color intensities of certain pixels and/or image regions forming the image. Decreasing the resolution of an image can pertain to decreasing the density of the pixels, and can result from diminishing variable color density values and/or color intensity of certain pixels and/or image regions forming the image. During a resolution conversion process, in certain embodiments of a display or projector, the footprint of pixels can be appropriately altered to effectively change the resolution of the at least one image.

Different embodiments of imaging systems 100 are described with respect to FIGS. 1 and 2. The imaging system 100 can pertain to any motion picture imaging system or still picture imaging system that is within the described intended scope of the present disclosure, unless otherwise indicated. The embodiment of imaging device 102 as described with respect to FIG. 1 includes a device operational capacity indicator 60, an image transformation estimator 62, and an image conversion portion 63. In certain embodiments, the device operational capacity indicator 60 can be operatively coupled to the imaging device 102, and can be configurable to estimate an operational capacity of the imaging device. In certain embodiments, but not others, the image transformation estimator 62 can be configurable to estimate whether the imaging device has adequate operational capacity to transform at least one image. In certain embodiments, the image conversion portion 63 can be configured to convert, or transform, the image according to certain parameters, such as described with respect to FIG. 1. These parameters include, but are not limited to, image resolution adjustment, image color level, intensity level, and/or exposure adjustment, metadata modification, image content recognition adjustment, image composition adjustment, and/or image content adjustment. As such, and in many embodiments, the image conversion portion 63 is configured as the device or engine that performs the image transformations that are estimated by the image transformation estimator 62.

Different illustrative embodiments of the device operational capacity indicator 60 can include, but are not limited to, an available energy indicator 64 that can be configurable to indicate an energy level of the imaging device 102; an available battery energy indicator 66 that can be configurable to include a battery energy level of the imaging device; an available device processing power indicator 68 that can be configurable to include an available processing power of the imaging device 102; an available device memory indicator 70 that can be configurable to include an available memory storage of the imaging device 102; an available computational time indicator 72 that can be configurable to include an available computation time of the imaging device 102; and/or other device operational capacity indicator(s) that indicate another similar device operational capacity.

Different illustrative embodiments of the image transformation estimator 62 can include, but are not limited to, an image resolution conversion estimator 80, an image content recognizer estimator 81, an image exposure adjustment estimator 82, an image metadata modification estimator 84, and/or an image composition adjustment estimator 86. Each image transformation estimator can be configurable to estimate the capacity of the imaging device to perform its respective imaging device transformation. It is to be understood that in different embodiments of the imaging devices 102, that all of, and/or certain portions of, the device operational capacity indicator 60 and/or the image transformation estimator 62 can be physically integrated within the imaging device, physically attached to the imaging device, and/or physically separated from the imaging device. It is also to be understood that in certain embodiments of the imaging devices 102, that all of, and/or certain portions of, the device operational capacity indicator 60 and/or the image transformation estimator 62 may be operatively coupled to the imaging device.

One embodiment of an imaging system 100 as described with respect to the block diagram of FIG. 1 is described with respect to FIG. 2. One embodiment of the imaging system 100 can include an imaging device 102, an optional peripheral imaging device 120, and an optional communication link 122. The imaging device 102 can be configurable to capture images. In different embodiments, the imaging device 102 can be alternatively configured as, but not limited to, a digital camera, a camcorder, a cellular phone with picture taking capabilities, a computer or PDA with image processing and/or picture taking capabilities, a printer, an image display etc. The imaging device 102 can be operationally sub-divided into an imaging portion 115 and data storage portion 114. Different embodiments of the imaging device 102 can capture, photograph, image, print, display, save, store-and-forward, or otherwise process a variety of images including, but not limited to, still images, motion images, video, audio, thumbprints, or other information relating to the images such as metadata. Different embodiments of the imaging device 102 can be configured to capture, obtain, retain, or otherwise process a variety of images including, but not limited to, color images, grayscale images, etc.

Many embodiments of imaging devices may be more technically complex or operationally sophisticated then conventional cameras, and as such may utilize contoller and/or computer technology as described with respect to FIG. 2. Certain embodiments of the imaging device 102 can include a controller 104 that performs the processing, imaging, operation, and other techniques that may be generally associated with the imaging device 102 that can benefit from utilizing automation of those image transforming techniques. Certain embodiments of the controller 104 include a processor 106, a memory 108, circuits 110, and/or an input/output (I/O) 112 that may include a bus (not shown). In general, increased capabilities of the controller 104 will enable greater image processing techniques by the imaging device 102, such as can be characterized by improved resolution conversion or resampling. Different embodiments of the controller 104 can include a general-purpose computer, a specific-purpose or devoted computer, a microprocessor, a microcontroller, and/or any other known suitable type of computer or controller that can be implemented in hardware, software, electromechanical devices, and/or firmware. In certain embodiments while not in other embodiments, some portions, or all of, the controller 104 can be physically or operationally configured in each imaging device. In certain embodiments, the processor 106 performs the processing, filtering, resolution conversion, arithmetic, and/or other operations for the controller 104 with respect to the imaging device 102. The controller 104 controls the signal processing, database querying and response, computational, timing, data transfer, and other processes associated with image networking.

Certain embodiments of the memory 108 can include random access memory (RAM) and read only memory (ROM) that together can store the computer programs, operands, and other parameters that control the operation of the shared imaging device. The bus provides for digital information transmissions between processor 106, circuits 110, memory 108, and I/O 112. The bus can in certain embodiments also connect I/O 112 to portions of the imaging devices, such as the peripheral imaging device 120 to suitably transfer data; which thereupon either receives digital information from and/or transmits digital information to other portions of the imaging system 100 or the imaging device 102.

I/O 112 can provide an interface to control the transmission of digital information between each of the components in the controller 104 and/or the imaging device 102. The I/O 112 can also provide an interface between the components of the controller 104 and different portions of the shared imaging device. The circuits 110 can include such other user interface devices as a display and/or a user input portion. The I/O 112 can thereby provide a mechanism by which image information, at least portions of images, and/or metadata associated with images can be transmitted between the imaging device 102 and other devices including, but not limited to, the peripheral imaging device 120 as shown in FIG. 2.

In another embodiment, the controller 104 can be constructed as a specific-purpose computer such as an application-specific integrated circuit (ASIC), a microprocessor, a microcomputer, or other similar devices. A distinct controller 104 can be integrated into certain embodiments of the imaging device 102, the peripheral imaging device 120 and/or the communication link 122, as described with respect to FIG. 2.

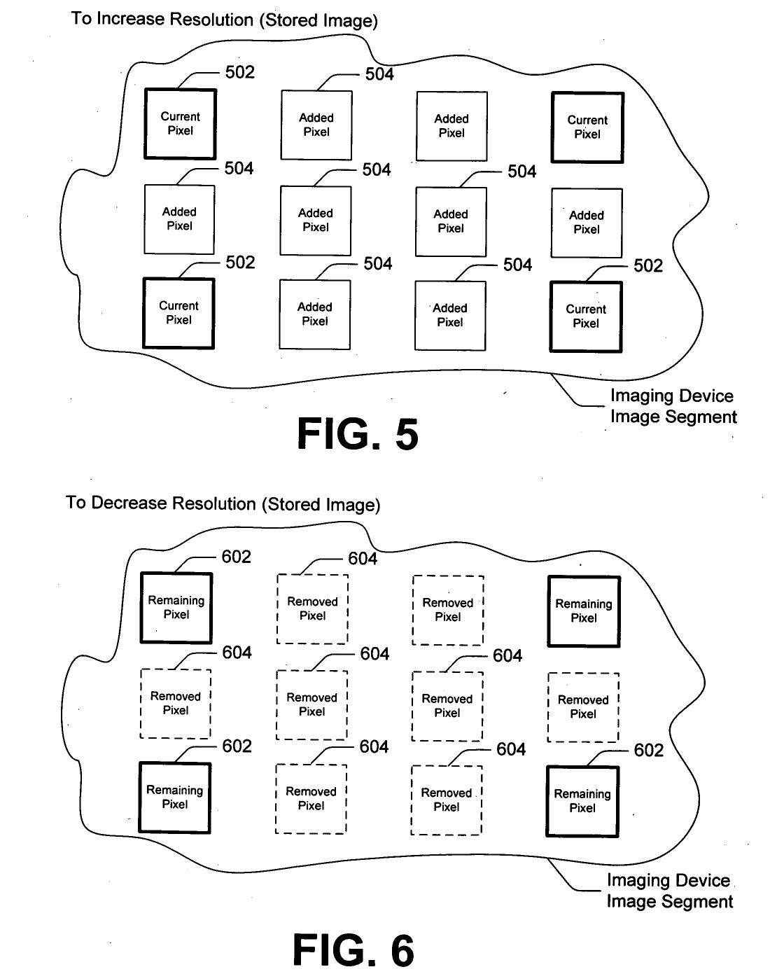

One embodiment of the imaging device 102 can be configured to convert the resolution of images that have been captured, retained, or obtained to a different resolution. This disclosure describes a variety of illustrative image transformation techniques for imaging devices as described with respect to FIGS. 5, 6, and 7 that are not considered to limit the scope of the present disclosure. For different embodiments of the imaging device 102, depending upon the functional purpose of the imaging device 102 and other considerations; the resolution can be converted from either a higher resolution to a lower resolution, or alternatively from a lower resolution to a higher resolution. One aspect of such resolution conversion as may be performed by many embodiments of the imaging devices 102 while not other embodiments, in that such resolution conversion or other image transformation techniques can consume a large amount of energy such as battery life.

One embodiment of an image transformation estimator configurable to estimate whether the imaging device has adequate operational capacity to transform at least one image includes, but is not limited by, an image resolution conversion energy monitoring technique. Certain embodiments can include obtaining an imaging device energy value for an imaging device. Certain embodiments can include considering a resolution conversion energy level to indicate whether the imaging device has the sufficient energy (to convert one or more images from a first resolution to a second resolution) based, at least in part, on the obtaining the imaging device energy value of the imaging device. Certain embodiments of the imaging devices, but not others, follow the following logic:
a) determining device capability:
b) determining operational resources necessary to perform an imaging device transformation; and
c) providing image transformation estimation by equating b) as a function of a).

The resolution level of the imaging device 102 can be adjusted manually, automatically, or semi-automatically, utilizing the different embodiments of the resolution conversion techniques as described herein. Such manual and/or semi-automatic adjustments of the imaging device can be performed, for example, by a user responding to input that can be displayed on the viewfinder; and based on the users previous experience, understanding the capacity (e.g., energy in certain embodiments) that might be necessary to perform the transformation. In other embodiments, altering of a resolution level can be performed substantially automatically utilizing the controller 104. For example, the controller 104 can receive input or monitor the current or recent energy state and/or life expectancy of the energy (or other capacity) of the imaging device, consider the amount of energy utilized by the imaging device 102 to convert the resolution of the at least one image based at least partially on the number of images whose resolution might be converted. The imaging devices 102 can contain a wide variety of displays to provide this information to the user. In many embodiments, the operational capacity indicator (e.g., an energy level indicator) of the imaging device can reduce the number of images that can be taken, and thereby increase the effective useful life of the imaging device. In many embodiments, but not others, it may be desirable to limit the energy consumed by the display similar to it being desirable to reduce the amount of energy utilized by the resolution conversion.

A variety of techniques for, and mechanisms to, provide resolution conversion (transformation) are now described. It should be remembered that image resolution conversion represents an example of image transformation, as described above with respect to FIG. 1 or 2. Certain embodiments of the image resolution conversion energy monitoring technique can also optionally include determining if the imaging device does have sufficient energy to convert the resolution of the one or more images, then the imaging device can convert the one or more images from the first resolution to the second resolution. If the imaging device does not have sufficient energy to convert the resolution of the one or more images, then the imaging device can transfer the one or more images from the imaging device to a second device that can alternatively be an imaging device or not an imaging device. Presumably, the energy level available to the second device (that can be configured in certain embodiments as a peripheral imaging device 120 and in other embodiments as a device) may not necessarily be sufficient to capture or photograph images, but instead may be sufficient to processes images. The ability to convert the resolution of the images may presumably be greater in the second device than in the imaging device, for example, the peripheral imaging device 120 can be a device that can be plugged into an electric outlet, or contain a larger battery, to receive a substantially continual supply of electricity.

In certain embodiments of display devices and/or projectors, a single pixel intensity can be implemented utilizing a plurality of neighboring pixels, in which each of the neighboring pixels can each have a substantially identical color value and intensity. As such, the plurality of pixels can act as a single pixel with a footprint that corresponds to the planar area encompassing the plurality of pixels.

Within this disclosure, imaging devices may be considered those devices configurable to process, image, capture, print, and/or display at least one image. The utilization of imaging capturing devices such as digital cameras, camcorders, photographing cellular phones, etc. has recently changed considerably (and may be expected to continue to change) as the expense of digital storage media continues to decrease while the storage capabilities, technology, and ease of operation of the digital storage media improves. Many embodiments of image capturing devices can be expected to perform processing operations more often associated with computers, as the technologies of the image capturing devices improve. Capturing images using digital cameras or camcorders can each be equated with photography as performed by conventional film cameras.

Advances in technology in imaging devices (such as the use of flash memory and other increased memory storage techniques) allows for data storage of a relatively large amount of image data within imaging devices. Such storage increase can be reflected by more images being stored and/or at least some of the images that can be stored, or portions thereof, having a greater resolution. In many embodiments of the imaging device as described within this disclosure, it might be envisioned that the imaging device can be provided with relatively sophisticated processing capabilities, which will allow for resampling and/or resolution conversion in a variety of image capturing, image printing, image storing, image displaying, or other image processing devices.

Resolution converting, resampling and/or other image transformations can be useful in a variety of applications including, but not limited to, where the image capturing device can perform processes that can utilize different versions or portions of an image (e.g., with different resolutions, etc.) and/or if different devices that may be operatively connected to the image capturing device can utilize different versions of the same image.

Certain embodiments of this disclosure thereby provide a mechanism or technique by which an image capturing device can resample or perform resolution conversion of images contained therein. Such resolution conversion, resampling and/or other image transformation techniques can be energy intensive, and therefore can utilize a considerable amount of energy from the battery of the digital camera. In many embodiments, such resampling by a device may thereby alter the number of pixels that can be set within an image. Images taken at different resolutions can be optimized for different purposes. For example, if one or more particular images can be intended to be displayed on a computer monitor, and the resolution of the computer monitor might be a limiting factor on the displayed resolution, than a relatively low resolution for the image may be completely satisfactory for its intended purpose. If a particular image could be printed on a relatively large sheet of paper, then it may be desired to have a relatively higher resolution image for its intended purpose.

Additionally, certain images can be utilized by more than one user, and/or for more than one purpose. For example, one user may wish to have a copy of an image at a particular resolution for one media, e.g., a computer monitor; and another copy of the same image at another resolution for another media, e.g., a printed copy. As such, it may be desired to resample or convert the resolution of a particular image based upon the intended use or desires of each particular user. In those instances where a camera's memory can only store a prescribed number of images, it may be desired to decrease the resolution of certain images, or alternatively, to increase the resolution of certain images, depending upon the particular use of, and/or the device utilizing, those images. As such, certain embodiments of this disclosure provide a mechanism by which a single image, or a group of images of a fixed or controllable size can be resampled therein.

Resolution conversion, or resampling, as performed by the resolution conversion portion of the imaging devices, can utilize a considerable amount of device capacity including, e.g., energy capacity and memory storage capacity. Such device energy capacity may be especially important for those devices that have a limited energy source, such as batteries. Within this disclosure, the imaging device energy capacity can represent a variety of techniques including internal battery life estimate, replaceable battery life estimate, auxiliary battery life estimate, or the like. As such, in this disclosure, the term “energy capacity” as applied to the imaging device may be intended to apply to the capacity of batteries or other energy sources that supply electrical power to the imaging device, regardless where the energy device can be located or mounted with respect to the imaging device. Some other power source from a battery, such as a continual energy supply or an uninterruptible or other energy supply, can also be applied to the imaging device while remaining within the scope of the present invention.

Many of the indicators 64, 66, 68, 70, and/or 72 that are included in the device operational capacity indicator 60, as described with respect to FIG. 1, are related to a limited energy that may be contained within the imaging device. As such, the indicated results of the capacity indicators may be interrelated, and a controller 104 may be effective in indicating, based on multiple energy considerations, the true operational capacity for the imaging device 102.

In one embodiment, this disclosure therefore provides a number of techniques by which the amount of energy of the imaging device 102, and/or that energy that can be utilized by the imaging device to perform the resolution conversion, can be estimated or monitored. The user of certain embodiments of the imaging device can thereby include an indicator that provides an indication of the energy necessary to perform the conversion, in many embodiments of which can then be compared on the indicator to the amount of energy currently available to the imaging device. Other embodiments of the imaging device can commence conversion of resolution of one or more images only in those circumstances that the imaging device has sufficient energy to perform the conversion.

In certain embodiments of the imaging device, the imaging device energy capacity can represent the device capacity, and can thereby be useful to estimate a resolution conversion for the imaging device (based on whether the imaging device has sufficient energy to perform the operation on one or more images). Each of the above-described device capacity techniques or mechanisms in certain embodiments can be used to estimate either alone, or in combination, some useful life for the imaging device. In actuality, many of the device capacities may be related since reduction of energy in one form may similarly affect an amount of energy that may be converted in another form within the imaging device. For example, an estimated available computation time capacity for a particular imaging device may relate to an estimated energy capacity for that imaging device, such that increasing the device's energy capacity leads to an increase in the devices computation time capacity and/the devices storage memory capacity.

Certain imaging device capacities can therefore, in certain embodiments, be considered as an estimate of some prescribed process state that can be performed by that imaging device. For example, if an imaging device has a limited energy supply that might be sufficient to capture some prescribed number of images, then the imaging device may not be able to be utilized after imaging that prescribed number of images without an energy source charge, insertion of new batteries, etc.

Different examples of a prescribed process when performed, may represent a device capacity drain. It may be understood that many of the certain embodiments of the imaging device's operational capacity capabilities can be heavily burdened by performing typical imaging and other processor-intensive operations. The device capacity thereby may be useful for estimating and/or monitoring potential image transformations for the user of the imaging device. The image transformations can therefore include, but are not limited to, altering a resolution of an image, capturing or imaging an image, operating a flash mechanism, obtaining an image, retaining an image, storing and/or forwarding an image, etc.

This disclosure thereby provides for a number of different embodiments of a mechanism or technique to estimate one or more operational resources of an imaging device that may be utilized to perform an image transformation. The mechanism or technique thereby estimates whether the imaging device has adequate operational capacity to perform the image transformation to transform the one or more images. Different embodiments of the image transformation estimator can include, but are not limited to, an image resolution conversion estimator 80, an image content recognizer estimator 81, an image exposure adjustment estimator 82, an image metadata modification estimator 84, and an image composition adjustment estimator 86.

By estimating whether the imaging device has adequate operational capacity to perform a particular image transformation allows the imaging devices (and/or the user thereof) to decide to perform the image transformation if it does, indeed, have sufficient operational capacity. However, if the imaging device does not have adequate device operational capacity, the imaging device (and/or the user thereof) can transfer the image information to another device, that does indeed have the capabilities to perform the image transformation or decide not to perform the image transformation. Another user option might be to indicate the amount of device capacity (e.g., energy) that would be required by the imaging device to perform the particular image transformation, and compare that to the total device capacity for that imaging device. As such, if a particular image transformation will consume a large percentage of the total device capacity for a particular imaging device, then the user of the device, or the device itself, may decide not to perform that image transformation.

A large variety of commercially-available imaging devices may include, but are not limited to: cameras, printers, facsimile machines, computers, personal display assistants (PDA), etc. Each imaging device includes some imaging program, such as produced with the hardware, software, or firmware, that may be configured to perform some imaging process that might be consonant with the intended purpose of the imaging device. Certain devices such as computers, PDAs, printers, display devices, processing devices, etc. can be provided with a substantially continuous energy supply such as an electric cord or a relatively large battery. Examples of imaging processing techniques whose operation utilizes a number of device resources, and as such may utilize the image transformation estimator 62 include, but are not limited to, data compression, data decompression, resolution enhancement, resolution reduction, noise reduction, filtering, etc. As such, in certain instances users of imaging devices can utilize a wide variety of image transformation estimators 62 as described with regards to FIG. 1 to consider whether it may be beneficial to transfer some or all of the images from a present imaging device 102 to another large-capacity device.

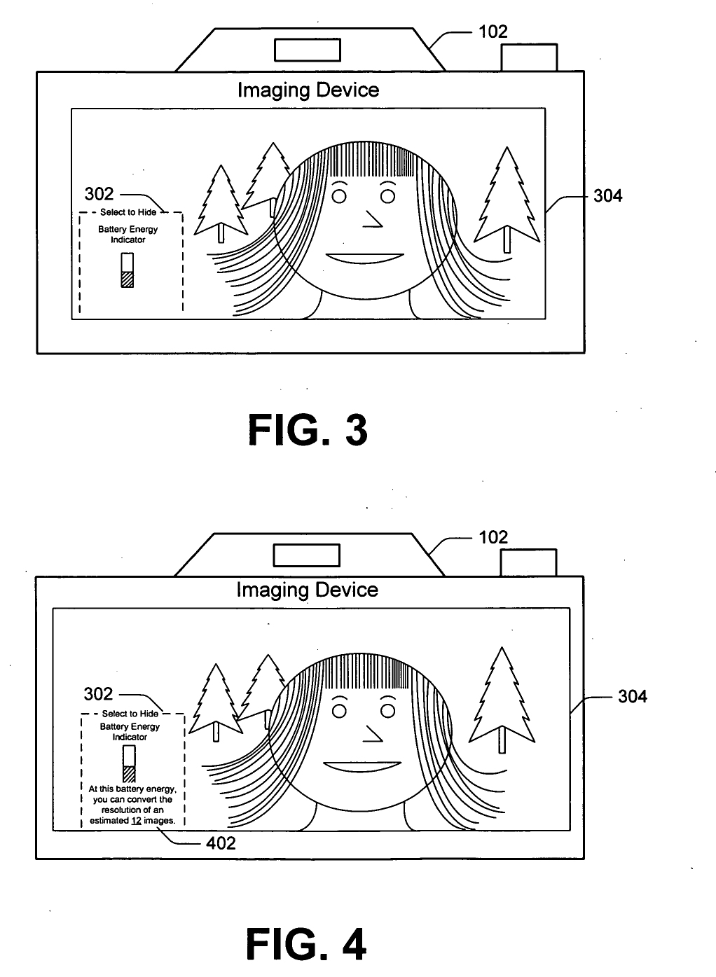

FIGS. 3 and 4 illustrate a front view of two embodiments of an imaging device 102 that can include one embodiment of an energy level indicator 302. In this disclosure, the energy level of a particular device can represent one embodiment of the device's operational capacity. As such, the energy level indicator 302 can represent, and be considered as, one embodiment of an operational capacity indicator. Certain embodiments of the energy level indicator 302 or operational capacity indicator may be configurable to indicate the total energy that the imaging device has remaining in its energy source such as, but not limited to: battery life, additional energy source life, etc. In one embodiment, the energy level indicator 302 might be provided within a display or viewfinder 304 that can be contained within the imaging device 102. Certain embodiments of the display or viewfinder 304 can be provided for such imaging devices as digital cameras or camcorders, and can include liquid crystal display (LCD) displays, optical displays, and a variety of other displays. In certain embodiments of the energy level indicator 302, the energy level indicator can be temporarily provided in a manner that can be controlled by the user of the imaging device 102. As such, if the user sought to see, or visually monitor, the energy level, then a menu-driven option could be selected or alternatively a button could be pressed to display (or alternatively, to deselect to not display) the energy level. In other embodiments of the imaging device 102, the energy level indicator 302 can be provided separately from the camera display or viewfinder such as being built in, as a separate display, within the body of the imaging device.

In one embodiment of the imaging device 102, the amount of energy utilized by the imaging devices to perform an image resolution conversion process of one, or more of the images can generally be determined based either on prior device history, or perhaps generally on operations by similar imaging devices. For example, a user of the imaging device 102 may understand that resolution conversion of 15 images having a particular pixel dimension (and color value) may utilize some percentage, such as 20 percent, of the energy of the imaging device. As such, in one embodiment, the energy level indicator 302 can be used to indicate the number of images that can be imaged by the imaging device based upon the current energy level of the imaging device. Within this disclosure, the amount of energy necessary to perform a particular resolution conversion is intended to be illustrative in nature, and not limited in scope. As an illustrative example, if the energy level indicator 302 indicates that the imaging device has 40% of its energy remaining, the user may not desire to perform a resolution conversion on a relatively large number of images (e.g., 50 images), and instead save the limited energy or other resources for other operations such as capturing images.

Such resolution conversion depending, at least in part, on energy of the imaging devices 102 can be automated, or semi-automated, as well by suitable programming within the controller 104. It may be desired in certain embodiments of the imaging device to illustrate the number of images that have their resolution converted, based on the particular energy level from the energy level indicator 302. For example, FIG. 4 shows one embodiment of an image resolution conversion numerical indicator 402 that indicates, based at least in part on the particular energy level indicated by the energy level indicator 302, that a prescribed number of images can have their resolution converted. In certain embodiments of the imaging device 102, while not in others, the structure and operation of the image resolution conversion numerical indicator 402 and the energy level indicator 302 can be associated with each other, and such association can be indicated on the camera display or viewfinder based largely upon their relative positioning. This relative positioning can include, but is not limited to, for example, positioning the two indicators 302, and 402 near to each other within the display or viewfinder 304, or in another portion of the imaging device for different embodiments of the imaging device.

The particular configuration of the energy level indicator 302 and the image resolution conversion numerical indicator 402, as illustrated with respect to FIG. 4, is intended to be illustrative in nature, while not limiting in scope. For example, the image resolution conversion numerical indicator 402 can also be a bar graph that indicates the number of similar images to those that may be considered to be resampled, that can be resampled, based upon the current energy level of the imaging device. As such, depending on the particular operation, dimension, and desired appearance of the image resolution conversion numerical indicator 402 or the energy level indicator 302, either of the indicators 402 or 302 can be configured as a numeric indicator, as text, as a bar graph, as a graph, as a percentage indicator, any other numerical percentage indicator, etc. as desired and/or appropriate. It is also to be understood that the indicators 302 or 402 can be configured to appear as desired based upon user input, device utilization, and device condition, and be non-visible during other times. For example, when a user might provide input to alter the resolution, it is likely that both indicators 302 and 402 should be made visible over the camera display or viewfinder. During other periods, the indicators 302 or 402 may not be shown in certain embodiments of the imaging device 102.

As described in this disclosure, there may be a number of embodiments of resolution conversion to be performed by certain embodiments of the imaging device 102. Such imaging conversion processes can be generally categorized as either increasing the resolution or decreasing the resolution of images being taken by, contained within, or retained within the imaging device 102.

FIG. 5 shows one embodiment of a resolution conversion process that increases the resolution of the images. Considering this resolution conversion technique, a number of current pixels 502 (four shown) may be contained in the original image prior to the resolution conversion process. A number of added pixels 504 (eight shown) may be added by the resolution conversion process. A color value can be assigned to each added pixel 504 depending upon the position of the added pixel with respect to one or more current pixels 502. For example, and in one embodiment, if an added pixel can be located between two current pixels, than each color value can be determined as a mathematical function based at least in part on the distance between the current pixels, and the color values of each current pixel. For example, the color value may be subdivided into a number of color values related to, e.g., red, green, and blue in one embodiment, or grayscale in another embodiment. For illustrative purposes only, assume that in the upper row of FIG. 5, the top left current pixel has a blue-color value of six, and the top right current pixel has the blue color value of nine. Suppose there are two added pixels between the two current pixels in the upper row. Following mathematical computations, in certain embodiments, the lefthanded added pixel in the upper row of FIG. 5 might be expected to have a blue color value of seven assigned thereto, while the right handed added pixel in the upper row might be expected to have a blue color value of eight.

Such mathematical computations can be applied to data storage in one dimension, two dimensions, and/or even three dimensions depending upon the design, usage, and/or configuration of the particular embodiment of the display or projector.

In certain instances that the color value does not mathematically round off evenly due to uneven spacing, the color value can be assigned to the next-closest integer or fractional value provided by the imaging device. Similar numerical computation can be performed for each of the green color value, red color value, and/or gray-scale color value supplied to the particular image(s) whose resolution can be converted. Such mathematical functions that may be utilized to derive the color values of the added pixels can depend, at least in part, on well-known and established mathematical weighing operations that could be performed within the controller 104 and as described with respect to FIG. 2.

One embodiment of the resolution conversion process, that can be utilized to increase at the resolution of a stored image, has been described with respect to the upper row of current pixels and added pixels in FIG. 5 along a single axis (e.g., in the horizontal direction). Such techniques can also be applied along another axis, or even along a diagonal, utilizing generally known weighting techniques such as described in a large variety of textbooks and articles, and commercially available in a variety of products.

In a number of embodiments of the resolution conversion techniques of certain imaging devices 102, the actual dimension (e.g., footprint) or the intensity of light generated by the pixel can be modified by the conversion. For example, FIG. 5 shows a number of embodiments of current pixels having a number of pixels added therebetween.

In certain embodiments, during a resolution conversion process, the current dimensions of the pixels may utilize a considerable amount of space, such that the display or viewfinder would not allow the addition of added pixels of the same dimension in between the current pixels. In those embodiments, the footprint of each current pixel over the display may be reduced in dimension, in such a manner that the added pixels can be physically inserted within an existing pixel array. In certain embodiments, to increase a resolution, the color intensity of the current pixels can be reduced, and a color intensity of the remaining pixels can compensate for the reduced intensity. As such, the overall color intensity values of the image can be maintained while the resolution of the image can be improved. The final image will likely appear sharper following the increase of resolution in many embodiments of the imaging devices 102. Such resolution conversion techniques will be understood by those experienced in resolution characteristics within cameras, etc.

Another embodiment of resolution conversion process such as can be performed by the controller 104 of FIG. 2 is described with respect to FIG. 6. The FIG. 6 embodiment of the resolution conversion process acts to decrease the resolution of the original image. For example, the original image will contain the remaining pixels 602 as well as the removed pixels 604. One embodiment of the resolution conversion process acts to remove any illumination or color projected by the removed pixels 604 from the original indenture to produce the decreased resolution image. As such, in certain embodiments, only certain pixels may be selected to be the remaining pixels 602 whose color values may be maintained, while the color values of the removed pixels 604 may be effectively discarded.

In another embodiment of the resolution conversion process that acts as a resolution reduction technique, as described with respect to FIG. 6, at least certain ones of the color values of the removed pixels might not be discarded, however they may be stored for latter computational or display use. Such embodiments of resolution reduction techniques can utilize stored color values for the removed pixels to, at least partially, reconstruct the original image. As such, certain embodiments of resolution conversion processes (including both the resolution reduction and resolution increasing techniques) would utilize a non-trivial amount of energy to perform.

In certain embodiments of the imaging device, during certain embodiments of the decreasing resolution technique such as described with respect to FIG. 6, the actual dimension of the remaining pixels can be modified, and/or the intensity of each of the pixels can be adjusted, to compensate for the removal of the removed pixels. For example, in one embodiment, as described with respect to FIG. 6, the color intensity information pertaining to each of the removed pixels can mirror one or more of the color values of the remaining pixels. For example, in one embodiment, assuming that the remaining pixel in the upper left-hand side of the array of pixels has a given color value, and multiple, e.g., five, the removed pixels can be assigned the same value (or any other selected remaining pixel). In another embodiment, each pixel area corresponding to a removed pixel can be assigned a new color intensity pixel value, relating to some weighted value pertaining to distances to proximate remaining pixels.

In yet other embodiments, one or more color or intensity values of a particular remaining pixel can be applied to similar areas as an original remaining pixel, wherein the actual dimensions of the image can be provided. As such, in the image as described with respect to FIG. 6, the final image may be e.g., some fraction as wide and another fraction as high as the original image.

By decreasing the resolution, in certain embodiments of the imaging device, a relatively large number of images can be stored and/or reviewed. In many embodiments, the resolution can be reduced without seriously altering the resulting images, depending partially on the intended use of the image. For example, assume that an imaging device can be utilized to capture relatively low quality images of, e.g., a house for sale. Under these instances, the resulting images of relatively low-resolution images may be satisfactory to convey the desired information about that particular application. As imaging and memory storage technology improves, many embodiments of imaging devices may be available with higher resolution capabilities on a more affordable basis. The present disclosure thereby provides a number of mechanisms for modifying resolution (either increasing or decreasing the resolution), after a particular image has been captured.

Examples of Estimating Image Transformation

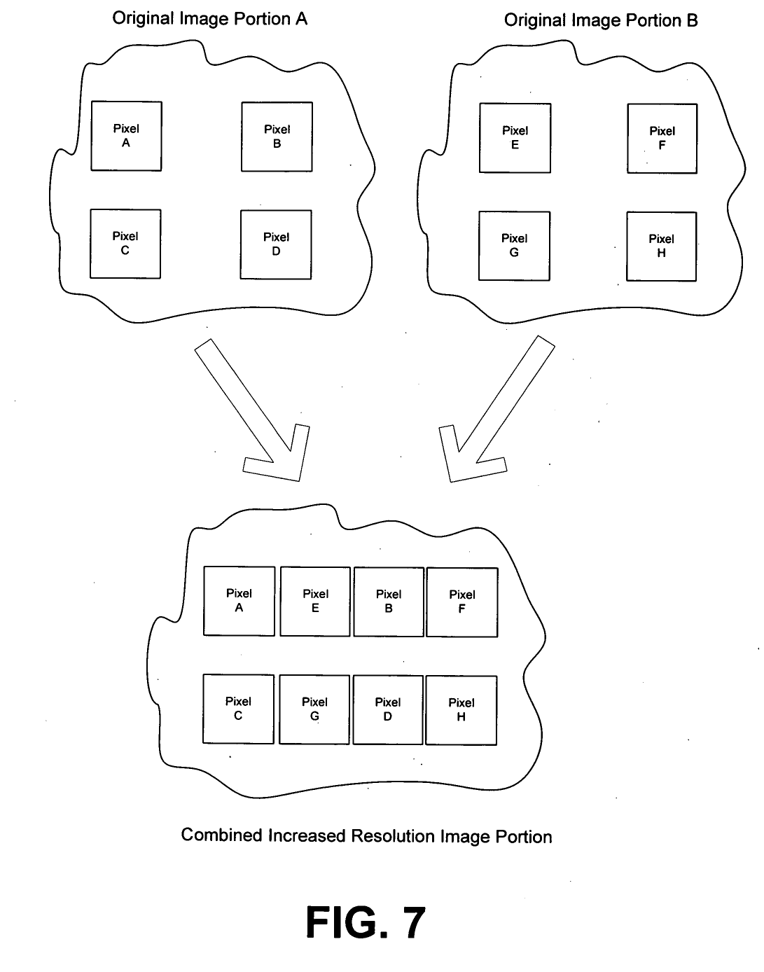

A number of illustrative implementation techniques for the imaging devices are now described. One embodiment of a resolution conversion process such as can be performed by controller 104 of FIG. 2 can be described with respect to FIG. 7. The FIG. 7 embodiment of the resolution conversion process acts to increase the resolution of the original image that might be processed to form the combined image. In general, the FIG. 7 embodiment of the resolution conversion process combines original image A with original image B to produce the combined image. The resolution conversion process relies upon interleaving the pixels from the original image A with the pixels from the original image B. While the original image A and the original image B is shown in FIG. 7 as having similar resolution, it is to be understood that the resolution of the original images can vary in many embodiments of the resolution conversion process. The pixels from the different original images can be interleaved within the same row, within the same column, on a diagonal basis, and/or any combination thereof. The embodiment of the resolution conversion process as described with respect to FIG. 7 therefore does not destroy any of the color values as described in this disclosure, but in fact interleaves the pixels while maintaining their color value to produce the combined image.

Certain embodiments of the resolution enhancement techniques as described with respect to FIG. 7 therefore may not utilize the degree of mathematical computation as with the resolution enhancement techniques described with respect to FIG. 5. In many embodiments, it may be important that at least portions of the original image portions be similarly located. In certain embodiments, however the original image portions can be taken from different angles, at different times, from different locations, etc. as desired by the user to create a desired image. Such combining of original images to create a desired combined image can, in certain embodiments, provide an impression of depth, or three-dimensionality, to the combined image as well as increasing the resolution of the combined image.

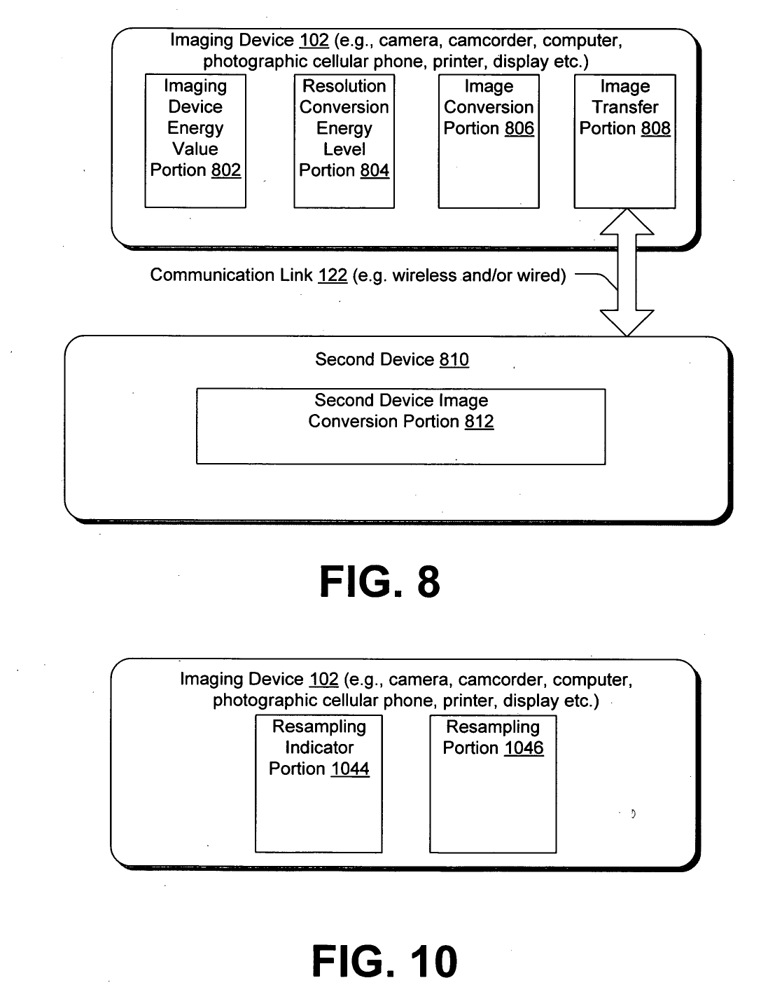

One embodiment of an imaging device 102 is described with respect to FIG. 8. One embodiment of the imaging device 102 can include, but is not limited to, an imaging device energy value portion 802, a resolution conversion energy level portion 804, an image conversion portion 806, and an image transfer portion 808. One embodiment of the imaging device energy value portion 802 can be considered as an example of the device operational capacity indicator 60, as described with respect to FIG. 1. One embodiment of the resolution conversion energy level portion 804 can be considered as an example of the image transformation estimator 62 as described with respect to FIG. 1. One embodiment of the image conversion portion 806 can be considered as an example of a mechanism that converts the resolution of the image using the techniques as described with respect to FIGS. 5 to 7. One embodiment of the image transfer portion 808 can be considered as one example of the communication link 122 as described with respect to FIG. 2 that can transfer data, image information, metadata associated with images, etc. between the imaging device 102 and a peripheral imaging device 120. As described with respect to FIG. 8, certain embodiments of the second device 810 can be configured as the peripheral imaging device 120 of FIG. 1, another imaging device that can image and/or share images, or a variety of other devices that are configured to either transmit image information to, or receive image information from, the imaging device 102. One embodiment of the second device image conversion portion 812 that is included in the second device 810 can be considered as another example of a mechanism that converts the resolution of the image utilizing, for example, the techniques as described with respect to FIGS. 5 to 7.

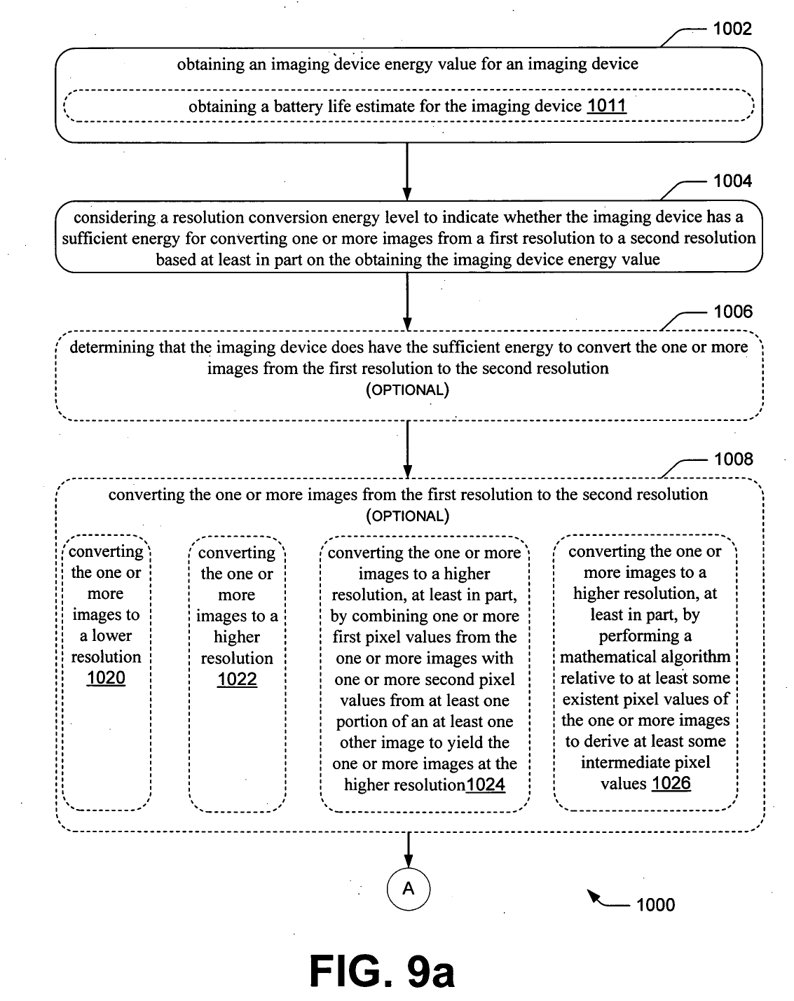

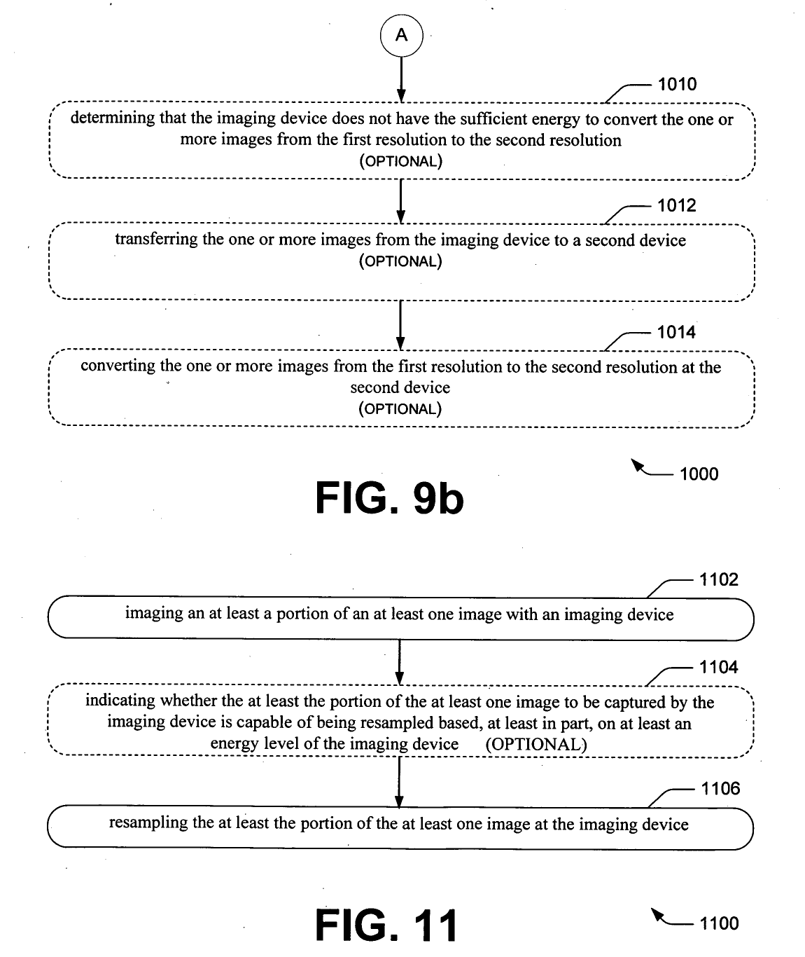

Within this disclosure, flowcharts (such as included as FIGS. 9a, 9b, 11, 13a, 13b, and 13c) are intended to relate to processes such as are typically protected by method claims and the like; and additionally the flowcharts are intended to apply to systems such as are typically protected by apparatus and/or system claims. These flowcharts may be described with respect to example diagrams of imaging devices, as included in FIGS. 1, 2, 8, 10, and 12. Additionally, these flowcharts may be described with respect to an image transformation, as described with respect to FIGS. 5, 6, and 7. These associations between the imaging devices and the flowcharts describing operations performed by the imaging devices are intended to be illustrative in nature, and not limiting in scope.

One embodiment of a high-level flowchart of the resolution conversion energy technique 1000 can be described with respect to FIGS. 9a and 9b, and which includes operations 1002, 1004; and additionally optional operations 1006, 1008, 1010, 1012, and 1014. The high-level flowchart of FIGS. 9a and 9b should be considered in combination with the imaging device 102, as described with respect to FIG. 8. Operation 1002 can include, but may not be limited to, obtaining an imaging device energy value for an imaging device. For example, obtaining an imaging device energy value using the imaging device energy value portion 802 of FIG. 8. Operation 1004 can include, but is not limited to, considering a resolution conversion energy level to indicate whether the imaging device has a sufficient energy for converting one or more images from a first resolution to a second resolution based at least in part on the obtaining the imaging device energy value. For example, considering a resolution conversion energy level to indicate whether the imaging device has sufficient energy for converting the resolution of one or more images using the resolution conversion energy level portion 804 as described with respect to FIG. 8. Operation 1006 can include, but is not limited to, determining that the imaging device does have the sufficient energy to convert the one or more images from the first resolution to the second resolution. For example determining whether the imaging device does have the sufficient energy to convert the resolution of the one or more images using, for example, the resolution conversion energy level portion 804 as described with respect to FIG. 8. Operation 1008 can include, but is not limited to converting the one or more images from the first resolution to the second resolution. For example, the imaging device 102 converts the resolution of the one more images, as described with respect to FIGS. 5 to 7 using the image conversion portion 806 as described with respect to FIG. 8. Operation 1010 can include, but is not limited to, determining that the imaging device does not have the sufficient energy to convert the one or more images from the first resolution to the second resolution. For example determining that the imaging device does not have the sufficient energy to convert the resolution of the one or more images using, for example, the resolution conversion energy level portion 804 as described with respect to FIG. 8. Operation 1012 can include, but is not limited to, transferring one or more images from the imaging device to a second device. For example, transferring at least one image from the imaging device 102 to the second device 810 using the image transfer portion 808 and the communication link 122, as described with respect to FIG. 8. Operation 1014 can include, but is not limited to, converting the one or more images from the first resolution to the second resolution at the second device. For example, the second device such as the peripheral imaging device 120 converting the resolution of the images using the image conversion portion 806, as described with respect to FIG. 8.

In operation 1002, the obtaining an imaging device energy value for an imaging device can include, but is not limited to, operation 1011, obtaining a battery life estimate for the imaging device. For example, the imaging device 102 of FIG. 8 utilizes the imaging device energy value portion 802, that can be configured as an available energy indicator 64, or an available battery energy indicator of 66, as described with respect to FIG. 1. In operation 1008, the converting the one or more images from the first resolution to the second resolution, can include but is not limited to, operation 1020, converting one or more images to a lower resolution. For example, converting the resolution of the images to a lower resolution using, for example, the image conversion portion 806, as described with respect to FIG. 8 to provide a conversion technique of FIG. 6. In operation 1008, the converting the one or more images from the first resolution to the second resolution can include, but is not limited to, operation 1022, converting one or more images to a higher resolution. For example, converting the image resolution to a higher resolution using the image conversion portion 806, as described with respect to FIG. 8 to provide a conversion technique of FIGS. 5, 7. In operation 1008, the converting the one or more images from the first resolution to the second resolution can include, but is not limited to operation 1024, converting the one or more images to a higher resolution, at least in part, by combining one or more first pixel values from the one or more images with one or more second pixel values from at least one portion of an at least one other image to yield the one or more images at the higher resolution. For example, the peripheral imaging device 120 converting the resolution of the images to a higher resolution using, for example, the image conversion portion 806, as described with respect to FIG. 8 to provide a conversion process of FIG. 7. In operation 1008, the converting the one or more images from the first resolution to the second resolution can include, but is not limited to, operation 1026, converting the one or more images to a higher resolution, at least in part, by performing a mathematical algorithm relative to at least some existent pixel values of the one or more images to derive at least some intermediate pixel values. For example, the peripheral imaging device 120 converting the resolution of the images to a higher resolution using, for example, the image conversion portion 806, as described with respect to FIG. 8 to provide a conversion process of FIG. 5.

One embodiment of an imaging device 102 is described with respect to FIG. 10. One embodiment of the imaging device 102 can include, but is not limited to, a resampling indicator portion 1044 and a resampling portion 1046. In one embodiment, the resampling indicator portion 1044 is an example of the image transformation estimator 62 as described above with respect to FIG. 1. One embodiment of the resampling portion 1046 can be considered as an example of a mechanism that converts the resolution of an image associated with the imaging device 102, utilizing for example the techniques as described with respect to FIGS. 5 to 7.

One embodiment of a high-level flowchart of a resampling technique 1100 is described with respect to FIG. 11, and includes operations 1102 and 1106; in addition to optional operation 1104 (whose order can be considered illustrative, and non-limiting). The high-level flowchart of FIG. 11 should be considered in combination with the imaging device 102, as described with respect to FIG. 10. Operation 1102 can include, but is not limited to, imaging an at least a portion of an at least one image with an imaging device. For example, imaging at the imaging device(s) 102 at least a portion of at least one image using the resampling indicator portion 1044, as described with respect to FIG. 10. Optional operation 1104 can include, but is not limited to, indicating whether the at least the portion of the at least one image to be captured by the imaging device can be capable of being resampled based, at least in part, on at least an energy level of the imaging device. For example, indicating that the image that has been captured has the energy level to be resampled using the resampling indicator portion 1044 of FIG. 10. Operation 1106 can include, but is not limited to, resampling the at least the portion of the at least one image at the imaging device. For example, the imaging device 102 resampling the at least one image using the resampling portion 1046 operatively coupled with the imaging device 102, as described with respect to FIG. 10.

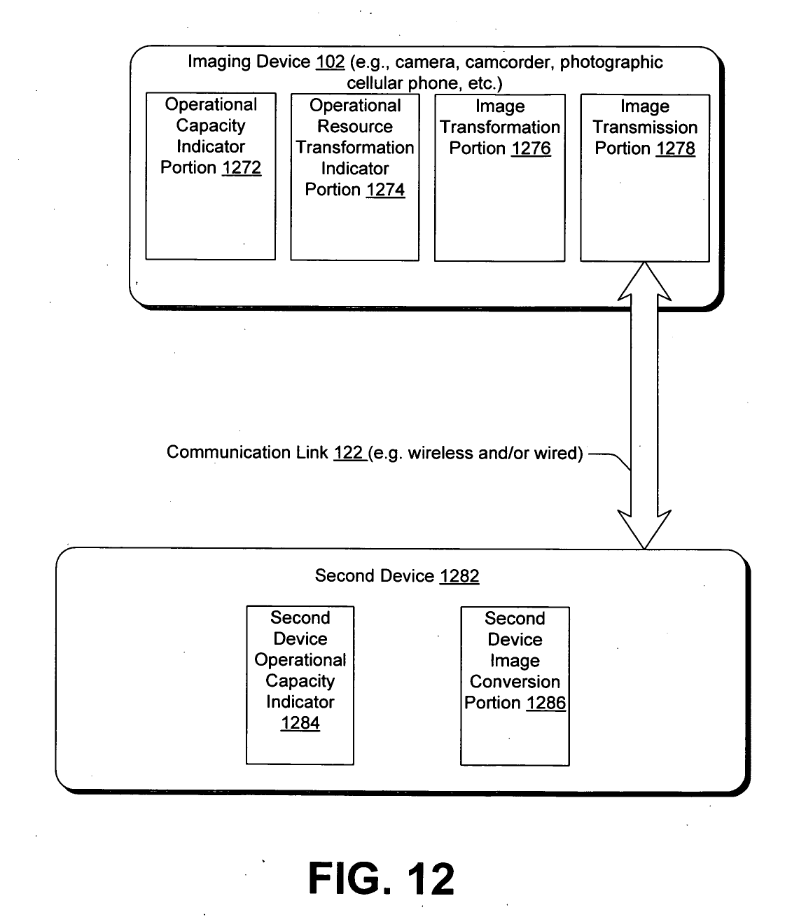

One embodiment of an imaging device 102, and an associated second device 1282, is now described with respect to FIG. 12. One illustrative embodiment of the imaging device 102 includes an operational capacity indicator portion 1272, an operational resource transformation indicator portion 1274, an image transformation portion 1276, and an image transmission portion 1278. One illustrative embodiment of the operational capacity indicator portion 1272 is configured as the device operational capacity indicator 60, as described above with respect to FIG. 1. One illustrative embodiment of the operational resource transformation indicator portion 1274 is configured as the image transformation estimator 62, as described with respect to FIG. 1. One illustrative embodiment of the image transformation portion 1276 is configured to perform the type of image transformations as described with respect to the image transformation estimator 62 of FIG. 1. One illustrative embodiment of the image transmission portion 1278 is configured to interface with the communication link 122 to provide communication between multiple imaging devices 102 utilizing, for example, wireless and/or wired-based networking techniques, such as described with respect to FIG. 2. In different embodiments, the second device 1282 can be configured as any device capable of transmitting to and/or receiving image information from the imaging device 102. Certain embodiments of the second device 1282 may include a second device operational capacity indicator 1284 and a second device image conversion portion 1286. One embodiment of the second device operational capacity indicator 1284 is configured similarly to the device operational capacity indicator 60, as described with respect to FIG. 1. One embodiment of the second device image conversion portion 1286 is configured to transform or convert the various parameters that pertained to image transformation (e.g., resolution version, exposure adjustment, image metadata modification, and/or image composition adjustment, as described with respect to the image transformation estimator 62 of FIG. 1.

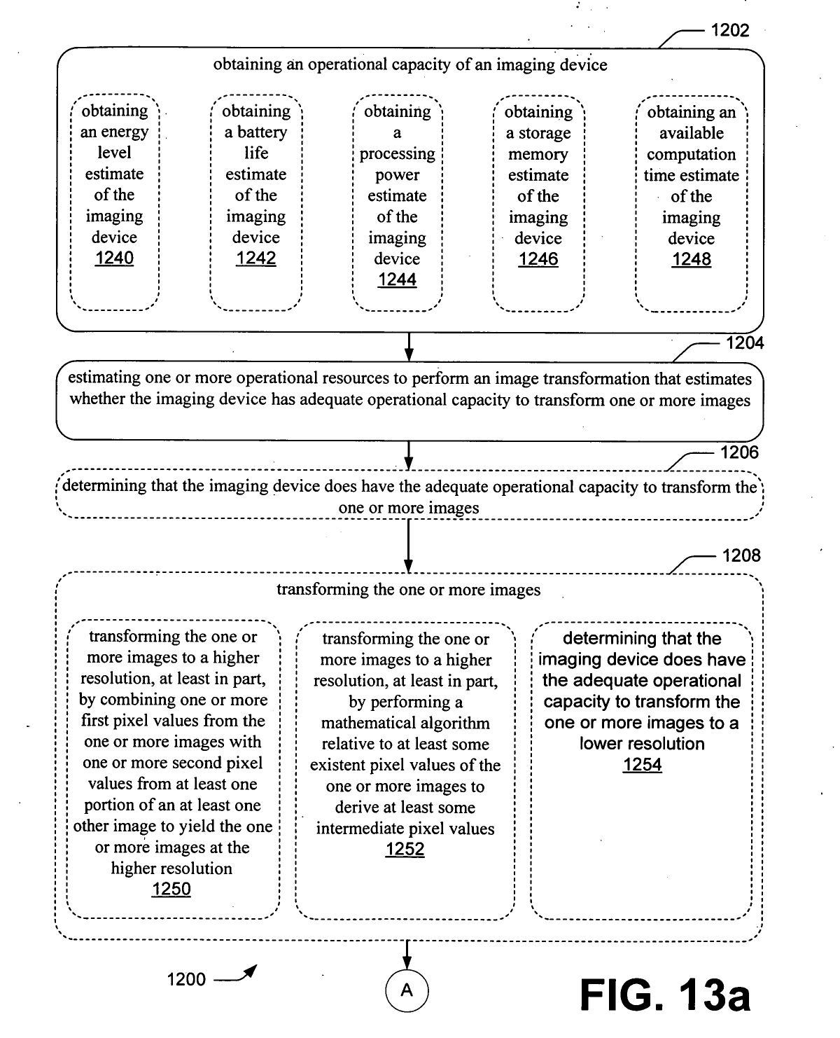

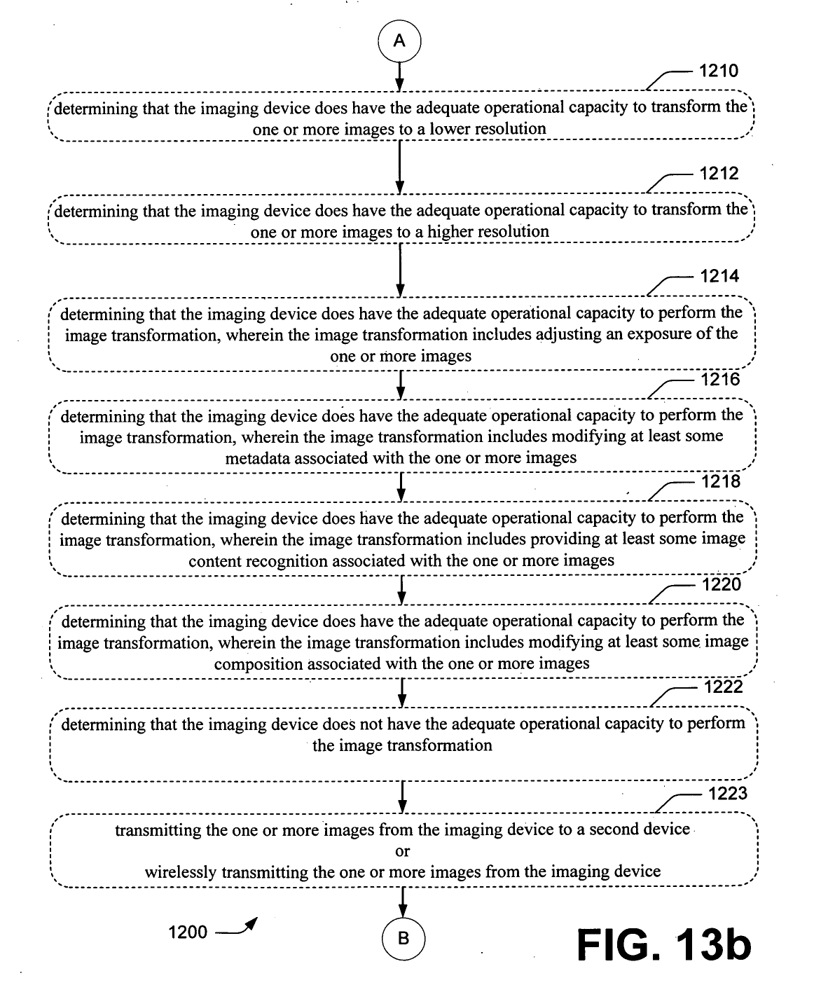

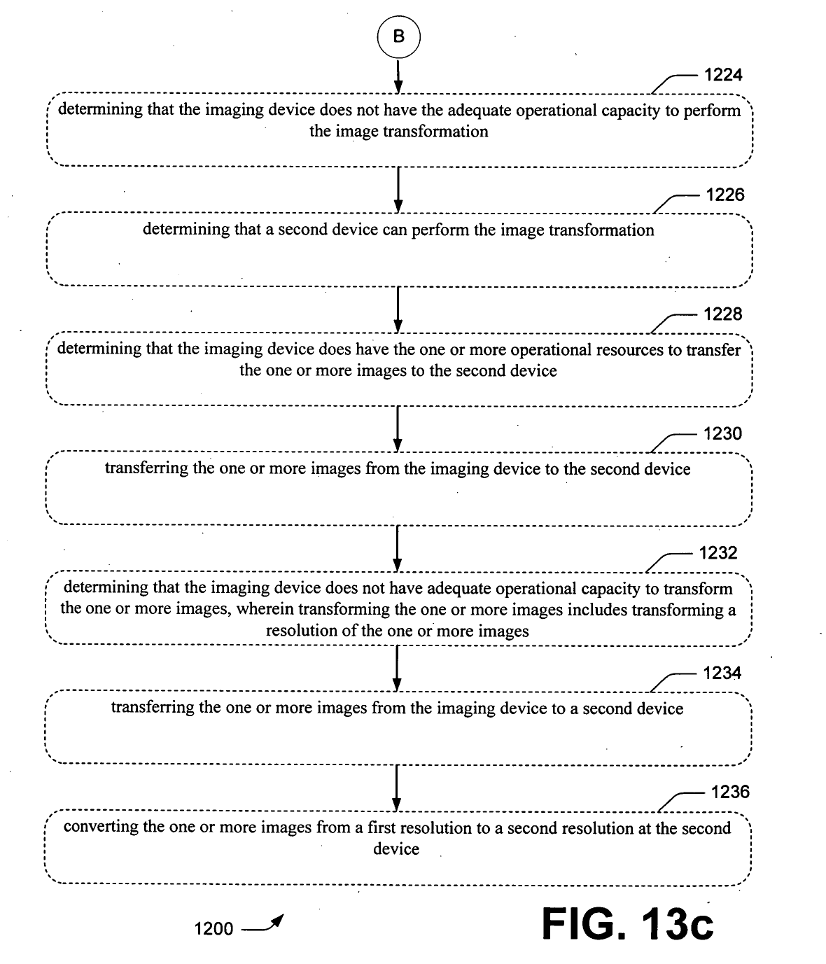

One embodiment of a high-level flowchart of an operational capacity technique 1200 is described with respect to FIGS. 13a, 13b, and 13c, and which includes operation 1202 and 1204; in addition to optional operations 1206, 1208, 1210, 1212, 1214, 1216, 1218, 1220, 1222, 1223, 1224, 1226, 1228, 1230, 1232, 1234, and 1236. The high-level flowchart of FIGS. 13a, 13b, and 13c should be considered in combination with the imaging device 102, as described with respect to FIG. 12. Operation 1202 can include, but is not limited to, obtaining an operational capacity of an imaging device. For example, obtaining an operational capacity of the imaging device(s) 102 using, for example, the operational capacity indicator portion 1272 as described with respect to FIG. 12. Operation 1204 can include, but is not limited to, estimating one or more operational resources to perform an image transformation that estimates whether the imaging device has adequate operational capacity to transform one or more images. For example, the imaging device 102 of FIG. 12, or the user thereof, estimates whether an operational resource can perform an image transformation using, for example, the operational resource transformation indicator portion 1274. Optional operation 1206 can include, but is not limited to, determining that the imaging device does have the adequate operational capacity to transform the one or more images. For example, the imaging device 102 of FIG. 12, or the user thereof, can determine that the imaging device has adequate operational capacity to transform the images using, for example, the operational resource transformation indicator portion 1274. Optional operation 1208 can include, but is not limited to, transforming the one or more images. For example, the imaging device 102 of FIG. 12 can transform the images using the image transformation portion 1276. Optional operation 1210 can include, but is not limited to, determining that the imaging device does have the adequate operational capacity to transform the one or more images to a lower resolution. For example, the imaging device 102 of FIG. 12, or the user thereof, can determine that the imaging device has adequate operational capacity, such as energy, to transform the images to a lower resolution using the operational resource transformation indicator portion 1274, to perform a transformation of FIG. 6. Optional operation 1212 can include, but is not limited to, determining that the imaging device does have the adequate operational capacity to transform the one or more images to a higher resolution. For example, the imaging device 102 of FIG. 12, or the user thereof, can determine that the imaging device has adequate operational capacity using, for example, the operational resource transformation indicator portion 1274, which to perform a transformation as described with respect to FIGS. 5 and 7. Optional operation 1214 can include, but is not limited to, determining that the imaging device does have the adequate operational capacity to perform the image transformation, wherein the image transformation includes adjusting an exposure of the one or more images. For example, the imaging device 102 of FIG. 12, or the user thereof, can adjust the exposure of the images using the operational resource transformation indicator portion 1274 that is configured as the image exposure adjustment estimator 82 of FIG. 1. Optional operation 1216 can include, but is not limited to, determining that the imaging device does have the adequate operational capacity to perform the image transformation, wherein the image transformation includes modifying at least some metadata associated with the one or more images For example, the imaging device 102 of FIG. 12, or the user thereof, can determine that the imaging device has adequate operational capacity to transform the images using the operational resource transformation indicator portion 1274 that is configured as the image metadata modification estimator 84 of FIG. 1. Optional operation 1218 can include, but is not limited to, determining that the imaging device does have the adequate operational capacity to perform the image transformation, wherein the image transformation includes providing at least some image content recognition associated with the one or more images. For example, the imaging device 102 of FIG. 12, or the user thereof, can determine that the imaging device has adequate operational capacity to transform the images using the operational resource transformation indicator portion 1274 that is configured as the image composition adjustment estimator 86 of FIG. 1. Optional operation 1220 can include, but is not limited to, determining that the imaging device does have the adequate operational capacity to perform the image transformation, wherein the image transformation includes modifying at least some image composition associated with the one or more images. For example, the imaging device 102 of FIG. 12, or the user thereof, can determine that the imaging device has adequate operational capacity to modify at least some image composition associated with the images using the operational resource transformation indicator portion 1274 that is configured as the image composition adjustment estimator 86 of FIG. 1. Optional operation 1222 can include, but is not limited to, determining that the imaging device does not have the adequate operational capacity to perform the image transformation. For example, the imaging device 102 of FIG. 12, or the user thereof, can determine that the imaging device does not have adequate operational capacity to transform the images using the operational resource transformation indicator portion 1274. Optional operation 1223 can include, but is not limited to, transmitting (either wirelessly or not) one or more images from the imaging device to a second device (either using a wireless communication link or another type of communication link). For example, transmitting the images from the imaging device 102 to the peripheral imaging device 120 using the image transmission portion 1278 and/or the communication link 122. Optional operation 1224 can include, but is not limited to, determining that the imaging device does not have the adequate operational capacity to perform the image transformation. For example, the imaging device 102 of FIG. 12, or the user thereof, can determine that the imaging device has adequate operational capacity to transform the images using the operational resource transformation indicator portion 1274. Optional operation 1226 can include, but is not limited to, determining that a second device can perform the image transformation. For example, the imaging device 102 of FIG. 12, or the user thereof, can determine that the peripheral imaging device 120 of FIG. 2 has adequate operational capacity to transform the images using the operational resource transformation indicator portion 1274. Optional operation 1228 can include, but is not limited to, determining that the imaging device does have the one or more operational resources to transfer the one or more images to the second device. For example, the imaging device 102 of FIG. 12, or the user thereof, can determine that the imaging device has adequate operational resources to transfer the images to a second device such as the peripheral imaging device 120 of FIG. 2 using the operational resource transformation indicator portion 1274. Optional operation 1230 can include, but is not limited to, transferring the one or more images from the imaging device to the second device. For example, the imaging device 102 of FIG. 12 transferring the images to the second device 1282 utilizing the image transmission portion 1278 and the communication link 122. Optional operation 1232 can include, but is not limited to, determining that the imaging device does not have the adequate operational capacity to transform the one or more images, wherein transforming the one or more images includes transforming a resolution of the one or more images. For example, the imaging device 102 of FIG. 12, or the user thereof, can determine that the imaging device does not have adequate operational capacity to transform the resolution of the images using the operational resource transformation indicator portion 1274. Optional operation 1234 can include, but is not limited to, transferring the one or more images from the imaging device to a second device. For example, the imaging device 102 of FIG. 12, or the user thereof, can transfer the images to the peripheral imaging device 120 using, for example, the image transmission portion 1278 and/or the communication link 122. Optional operation 1236 can include, but is not limited to, converting one or more images from a first resolution to a second resolution at the second device. For example, the imaging device 102 of FIG. 12 converts the resolution of images using, for example, the image transformation portion 1276.

Certain embodiments of the operation 1202, the obtaining an operational capacity of an imaging device, can include optional operation 1240, obtaining an energy level estimate of the imaging device. For example, one embodiment of the operational capacity as described with respect to the operational capacity indicator portion 1272 of FIG. 12 can be the available energy indicator 64 of FIG. 1. Certain embodiments of operation 1202, the obtaining an operational capacity of an imaging device, can include optional operation 1242, obtaining a battery life estimate of the imaging device. For example, one embodiment of the operational capacity as described with respect to the operational capacity indicator portion 1272 of FIG. 12 can be the available battery energy indicator 66 of FIG. 1. Certain embodiments of operation 1202, obtaining an operational capacity of an imaging device, can include optional operation 1244, obtaining a processing power estimate of the imaging device. For example, one embodiment of the operational capacity as described with respect to the operational capacity indicator portion 1272 of FIG. 12 can be the available device processing power indicator 68 of FIG. 1. Certain embodiments of operation 1202, obtaining an operational capacity of an imaging device, can include optional operation 1246, obtaining a storage memory estimate of the imaging device. For example, one embodiment of the operational capacity as described with respect to the operational capacity indicator portion 1272 of FIG. 12 can be the available device memory indicator 70 of FIG. 1. Certain embodiments of operation 1202, obtaining an operational capacity of an imaging device, can include operation 1248, obtaining an available computation time estimate of the imaging device. For example, one embodiment of the operational capacity as described with respect to the operational capacity indicator portion 1272 of FIG. 12 can be the available computation time indicator 72 of FIG. 1. Certain embodiments of optional operation 1208, transforming the one or more images, can include optional operation 1250, transforming the one or more images to a higher resolution, at least in part, by combining one or more first pixel values from the one or more images with one or more second pixel values from at least one portion of an at least one other image to yield the one or more images at the higher resolution. For example, the image transformation portion 1276 of the imaging device 102, of FIG. 12, being configured to transform images to a higher resolution by including pixel values from multiple images, as described with respect to FIG. 7. Certain embodiments of optional operation 1208, transforming the one or more images, can include optional operation 1252, transforming the one or more images to a higher resolution, at least in part, by performing a mathematical algorithm relative to at least some existent pixel values of the one or more images to derive at least some intermediate pixel values. For example, the image transformation portion 1276 of the imaging device 102, of FIG. 12, being configured to transform images to a higher resolution by utilizing a mathematical algorithm, as described with respect to FIG. 5. Certain embodiments of optional operation 1208, transforming the one or more images, can include optional operation 1254, determining that the imaging device does have the adequate operational capacity to transform the one or more images to a lower resolution. For example, the image transformation portion 1276 of the imaging device 102, of FIG. 12, being configured to transform images to a lower resolution, as described with respect to FIG. 6.

### Conclusion

Those having skill in the art will recognize that the state of the art has progressed to the point where there may be in many embodiments little distinction left between hardware, firmware, and software implementations of aspects of systems; hardware, firmware, or software is generally (but not always, in that in certain contexts the choice between hardware, firmware, and software can become significant) the use of a design choice representing cost vs. efficiency tradeoffs. Those having skill in the art will appreciate that there may be various vehicles by which processes and/or systems and/or other technologies described herein can be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for mainly a hardware and/or firmware vehicle; alternatively, if flexibility might be paramount in certain embodiments, the implementer may opt for mainly a software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, “operably linked”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It is to be understood by those skilled in the art that, in general, that the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term “includes” should be interpreted as “includes, but is not limited to”; etc. In this disclosure and the appended claims, the terms “a”, “the”, and “at least one” located prior to one or more items are intended to apply inclusively to either one or a plurality of those items.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

Within this disclosure, elements that perform similar functions in a similar way in different embodiments may be provided with the same or similar numerical reference characters in the figures.

1. A method, comprising:
obtaining an imaging device energy value for an imaging device; and
considering a resolution conversion energy level to indicate whether the imaging device has a sufficient energy for converting one or more images from a first resolution to a second resolution based at least in part on the obtaining the imaging device energy value.

2. The method of claim 1, wherein the method further comprises:
determining that the imaging device does have the sufficient energy to convert the one or more images from the first resolution to the second resolution; and
converting the one or more images from the first resolution to the second resolution.

3. The method of claim 2, wherein the converting the one or more images from the first resolution to the second resolution comprises:
converting the one or more images to a lower resolution.

4. The method of claim 2, wherein the converting the one or more images from the first resolution to the second resolution comprises:
converting the one or more images to a higher resolution.

5. The method of claim 2, wherein the converting the one or more images from the first resolution to the second resolution comprises:
converting the one or more images to a higher resolution, at least in part, by combining one or more first pixel values from the one or more images with one or more second pixel values from at least one portion of an at least one other image to yield the one or more images at the higher resolution.

6. The method of claim 2, wherein the converting the one or more images from the first resolution to the second resolution comprises:
converting the one or more images to a higher resolution, at least in part, by performing a mathematical algorithm relative to at least some existent pixel values of the one or more images to derive at least some intermediate pixel values.

7. The method of claim 1, wherein the method further comprises:
determining that the imaging device does not have the sufficient energy to convert the one or more images from the first resolution to the second resolution; and
transferring the one or more images from the imaging device to a second device.

8. The method of claim 1, wherein the method further comprises:
determining that the imaging device does not have the sufficient energy to convert the one or more images from the first resolution to the second resolution;
transferring the one or more images from the imaging device to a second device; and
converting the one or more images from the first resolution to the second resolution at the second device.

9. The method of claim 1, wherein the obtaining an imaging device energy value for an imaging device comprises:
obtaining a battery life estimate for the imaging device.

10.-32. (canceled)

33. A method, comprising:
obtaining an operational capacity of an imaging device; and
estimating one or more operational resources to perform an image transformation that estimates whether the imaging device has adequate operational capacity to transform one or more images.

34. The method of claim 33, wherein the method further comprises:
determining that the imaging device does have the adequate operational capacity to transform the one or more images; and
transforming the one or more images.

35. The method of claim 34, wherein the transforming the one or more images comprises:
transforming the one or more images to a higher resolution, at least in part, by combining one or more first pixel values from the one or more images with one or more second pixel values from at least one portion of an at least one other image to yield the one or more images at the higher resolution.

36. The method of claim 34, wherein the transforming the one or more images comprises:
transforming the one or more images to a higher resolution, at least in part, by performing a mathematical algorithm relative to at least some existent pixel values of the one or more images to derive at least some intermediate pixel values.

37. The method of claim 33, wherein the method further comprises:
determining that the imaging device does have the adequate operational capacity to transform the one or more images to a lower resolution.

38. The method of claim 33, wherein the method further comprises:
determining that the imaging device does have the adequate operational capacity to transform the one or more images to a higher resolution.

39. The method of claim 33, wherein the method further comprises:
determining that the imaging device does have the adequate operational capacity to perform the image transformation, wherein the image transformation includes adjusting an exposure of the one or more images.

40. The method of claim 33, wherein the method further comprises:
determining that the imaging device does have the adequate operational capacity to perform the image transformation, wherein the image transformation includes modifying at least some metadata associated with the one or more images.

41. The method of claim 33, wherein the method further comprises:
determining that the imaging device does have the adequate operational capacity to perform the image transformation, wherein the image transformation includes providing at least some image content recognition associated with the one or more images.

42. The method of claim 33, wherein the method further comprises:
determining that the imaging device does have the adequate operational capacity to perform the image transformation, wherein the image transformation includes modifying at least some image composition associated with the one or more images.

43. The method of claim 33, wherein the method further comprises:
determining that the imaging device does not have the adequate operational capacity to perform the image transformation; and
transmitting the one or more images from the imaging device to a second device.

44. The method of claim 33, wherein the method further comprises:
determining that the imaging device does not have the adequate operational capacity to perform the image transformation; and
wirelessly transmitting the one or more images from the imaging device to a second device over a wireless link.

45. The method of claim 33, wherein the method further comprises:
determining that the imaging device does not have the adequate operational capacity to perform the image transformation;
determining that a second device can perform the image transformation;
determining that the imaging device does have the one or more operational resources to transfer the one or more images to the second device; and
transferring the one or more images from the imaging device to the second device.

46. The method of claim 33, wherein the method further comprises:
determining that the imaging device does not have the adequate operational capacity to transform the one or more images, wherein the transforming the one or more images includes transforming a resolution of the one or more images;
transferring the one or more images from the imaging device to a second device; and
converting the one or more images from a first resolution to a second resolution at the second device.

47. The method of claim 33, wherein the obtaining an operational capacity of an imaging device comprises:
obtaining an energy level estimate of the imaging device.

48. The method of claim 33, wherein the obtaining an operational capacity of an imaging device comprises:
obtaining a battery life estimate of the imaging device.

49. The method of claim 33, wherein the obtaining an operational capacity of an imaging device comprises:
obtaining a processing power estimate of the imaging device.

50. The method of claim 33, wherein the obtaining an operational capacity of an imaging device comprises:
obtaining a storage memory estimate of the imaging device.

51. The method of claim 33, wherein the obtaining an operational capacity of an imaging device comprises:
obtaining an available computation time estimate of the imaging device.

52.-68. (canceled)

69. A system comprising:
circuitry for obtaining an imaging device energy value for an imaging device; and
circuitry for considering a resolution conversion energy level to indicate whether the imaging device has a sufficient energy for converting one or more images from a first resolution to a second resolution based at least in part on the obtaining the imaging device energy value.
